(19) United States
(12) Patent Application Publication
(10) Pub. No.: US 2005/0106391 A1
(43) Pub. Date: May 19, 2005

(54) Centrifugal spinning process

(76) Inventors: Anthony Carl Lawrence, West Yorkshire (GB); Rezin Mohammad Mahmoudi, West Yorkshire (GB)

Correspondence Address: MYERS BIGEL SIBLEY & SAJOVEC, PO BOX 37428, RALEIGH, NC, 27627, US

(21) Appl. No.: 10/495,582

(22) PCT Filed: Nov. 14, 2002
(86) PCT No.: PCT/GB02/05119

(30) Foreign Application Priority Data
Nov. 14, 2001 (GB) 01273275

(51) Int. Cl. B28B 1/54; B22F 9/00

(52) U.S. Cl. 428/375; 264/8; 425/8

(57) ABSTRACT

A fiber or filament having a substantially amorphous outer surface and a more oriented core is disclosed. Additionally, a centrifugal spinning apparatus including an annular spinning member provided with an inlet end and an outlet end, the annular spinning member being rotatably mounted on an axis, and being provided with a coaxially mounted spinning plate, drive means for rotating the annular member and the plate, the apparatus also being provided with material feed means having an exit in the annular member adjacent the plate, the member having a plurality of spinning points formed on the external periphery of the outlet end thereof and grooves which extend across the outlet end of the spinning member from the interior surface to the external periphery thereof to direct material in liquid form to the spinning points and wherein axial directed cooling means is provided at the inlet end of the annular spinning member characterized in that, external to the outlet end of the spinning member, the apparatus is provided with one or more axially extending baffles.

This invention relates to a novel material and to a novel process for its preparation.

European Patent Application No. 0 469 473 describes a centrifugal spinning apparatus comprising, inter alia, a bowl or annular member from which a liquid medium, e.g. a solution or melt, is spun therefrom. In particular, the apparatus is provided with a plurality of spinning points formed on the external periphery of an end member and grooves which extend across the interior surface to the external periphery to direct material in liquid form to the spinning points.

Moreover, the improved axial cooling enables fibres or filaments to be produced which are distinct from the staple fibres produced by the prior art. Indeed the fibres or filaments produced are novel per se and posses novel properties. The novel fibres generally comprise an outer, substantially amorphous, skin or shell with a core of more orientated polymer chains. The more oriented core may usually be a substantially crystalline core.

Prior art attempts to produce such fibres have generally utilised a non-uniform and/or lateral air flow which results in filaments which may have a crystalline portion of one half of the fibre and an amorphous portion on the second half of the fibre. Furthermore, prior art systems have, generally, been unable to produce continuous filaments. Therefore, the fibres produced from the apparatus of the prior art are generally short, stable fibres.

There has therefore long been a need for a method of producing continuous filament yarns by a centrifugal spinning process. However, we have now surprisingly found that by incorporating one or more baffles into the apparatus, which are generally coaxial with the rotating disc, much improved axial cooling of the fibre is achieved (to produce a continuous filament yarn).

Thus according to the invention, we provide a fibre filament which comprises a substantially amorphous outer surface and a more oriented core.

By the term “more oriented”, we mean, for example, a core comprising a series of connected elements, for example, a series of polymer chains, which are oriented, e.g. aligned together, or substantially oriented as opposed to the disoriented, amorphous outer portion. Such a core may, preferentially, be substantially crystalline.

The fibres or filaments of the invention may be manufactured so that the chemical nature of the outer surface and the core may comprise the same chemical moiety, eg a polymer. However, alternatively the fibre or filament may comprise a bicomponent material, that is, a material wherein the outer surface moiety is different to the inner core moiety. Generally, in such bicomponent systems will comprise a relatively dense core and a relatively less dense out surface. Thus, for example, a bicomponent system may comprise a polypropylene/polyethylene composite. Such a composite may thus comprise a dense polypropylene core with a less dense polyethylene outer surface. Alternatively, the composite may comprise a dense polyethylene core with a less dense polypropylene outer surface.

The dimensions of the amorphous outer surface and the crystalline core may vary, depending upon, inter alia, the size of the fibre or filament, the chemical nature of the fibre or filament, etc. However, generally, for a fibre or filament with a median diameter of about 50 μm the amorphous outer surface may be from 0.5 to 10 μm in thickness. Thus the amorphous outer surface may comprise from 1 to 20% of the thickness of the fibre or filament.

The novel fibres or filaments of the invention also possess unique and novel properties.

Conventionally, in fibre/filament manufacture a fibre or filament is drawn and then separately bulked by false twisting or other means. The drawing and bulking process or filaments of the present invention is that they are self bulking, eg when stretched they return in a non-resident manner and bulking occurs.

According to one aspect of the invention we provide a fibre as hereinbefore described. In an alternative aspect of the invention we provide a filament as hereinbefore described.

Thus according to a further feature of the invention we provide a self bulking fibre or filament which comprises a fibre or filament as hereinbefore described.

According to this aspect of the invention, we also provide a method of bulking a fibre or filament as hereinbefore described which comprises cold drawing, stretching and releasing a fibre or filament.

The novel fibres and filaments of the invention can be applied to a variety of materials which are illustrated by, but shall not be limited to those hereinafter described.

The rapid production of filaments from thermally sensitive polymers, in particular biopolymers and high temperature polymers that readily degrade at their melting points. It is believed that the short duration of the flow down the wall of the bowl limits the degradation time.

Self—bulking filament yarns. Filament yarns are given texture by crimping the filaments to give the yarn bulk. The conventionally used processes are false twist texturing or air-jet texturing. With former, the filament is heated to a point where an applied torsional stress by false-twisting causes plastic deformation, then cooling traps the deformation and the untwisted filaments retain a crimp state that gives the yarn bulk. The air-jet method causes the filament to form a multiplicity of loops along their lengths. During their formation inter-filament entanglement of the loops occur giving the yarn bulk. An alternative approach to these down-line processes is to asymmetrically cool the molten filament streams during the melt spinning technique. This causes the polymer chains on one side of the filament to be less elongated than on the other as tension is applied to spinning line during the solidification process. The resulting effect in subsequent solid-state drawing or heat-treating of the filaments is filament bulking. The disadvantage is that each filament adopts a helical shape that does not give the required filament yarn characteristics in terms of handle, flexural rigidity, etc. The spinning line tension will cause more straightening of the polymers in the bulk (or core) than at the surface. Cold solid-state drawing leads to self-bulking. Since all the surface is differentially cooled in comparison to the core, the filament crimp is not a spiral one but is similar to that of false twist texturing. The cold solid-state drawing can be carried out in line with the melt spinning action to make an integrated spin-texture process. As is explained below it is possible to make bi-component filaments with one type of polymer forming the core and another the surrounding sheath. If the sheath is sufficiently thin, then a highly self-textured yarn could be made.

Conductive fibres and filaments. A range of conductive materials can be made by:—Feeding metal particles, or conductive polymers, with the main resin chips: thus loading the molten streams with conductive particles.

Placing a conductive (metal) filament down a centre hole of the drop plate whilst spinning the resin chips into multi-filaments. These filaments will twist around the filament core to form a conductive filament core-spun yarn.

Combinations of the above may be manufactured, for example, by introducing low melting point metals with the resin chips, it is considered likely that the differences in surface tension and density of the materials would result the metal forming the core and the polymer the skin of multi-filament yarn.

Bi-component & multi-component Filaments and fibres: based on the idea of mixing resins of differing surface tensions, densities and melting points (within a certain range) it is likely that multi-component polymer filament can be produced, some with a core/skin layer morphology. Many of these would be novel fibres. Currently only bi-component fibres have reported.

Porous fibres/filaments: based on the concept of loading the polymer streams with foreign particles, it is likely that thermally volatile particular substances can be incorporated in the streams which result in blow holes in the solidified polymer filaments/fibres.

Hollow Fibres/filaments: It is believed that these can be made in two ways. One would be the result of appropriate spinning point geometry enabling the surface tension of a ribbon-like molten stream to curl across its width and from a tubular filament. The other approach would be to produce bi-component filaments/fibres of a core-sheath morphology, and then dissolving the core in a solvent to which the sheath is resistant.

Ceramic precursor fibres/filaments: Such fibres can be made directly from solution containing metal oxides, these fibres would then be heat treated to form ceramic fibres. An alternative is to use the loaded polymer stream approach in which the foreign particles are fine inorganic powders. Subsequent heat treatment would produce ceramic fibres.

Fibre reinforced composite precursor filaments: This is based on the idea of feeding a core filament down the centre of the bowl and drop plate. The core filament would be the reinforcing material, i.e. glass, carbon fibre, etc, and the melt-spun filaments twisted around the core would be made from the composite matrix material. By suitable adjustment of the melt spinning temperature and the rate of cooling the spun filaments can be made to adhere to the reinforcing filaments. The core yarn can be woven, knitted, braided, or filament wound into the required shape of the end product. These shapes would then be heat treated to form the fibre-reinforced composite. Commercially, the melt-spun filaments are intermingled with the reinforcing filament by a separate process to melt spinning. This process is similar to air-jet texturing.

Highly wicking filaments: By suitably designing the spinning points it is possible produced a yarn whereby pairs of filaments are fused together along their lengths. This results in two capillaries with each fused filament pair. The capillaries will facilitate fast wicking. Fabrics made from such filament yarns will have good wicking properties. Commercial fibres/filament made with special geometries to improve the wicking characteristics of fabrics have the disadvantage that when twisted together prior to weaving or knitting, the level of twist inserted can alter the geometry and reduce or, in the case of capillary constriction, even prevent wicking.

Ultra-fine/nanofibres: By adjusting the amount of polymer film flowing down the bowl and using suitably sized spinning points very fine fibres can be made, i.e. micro fibres <1 dtex. A suitably position second bowl made to rotate at a higher speed in the same or opposite direction to the spinning bowl would highly stretch the molten filament streams making contact with this second bowl. This stretching would attenuate the filament to extremely fine diameters of the order of 100 nm, to form nanofibres. Currently there is no commercially viable process for producing nanofibres. Techniques being studied are based on electrostatic spinning using high voltages of the order of 30 kV. The practical health and safety difficulties associated with this approach combined with extremely low production rates greatly restrict the development of nanotextile technology.

Non-woven fabrics: Commercial non-woven processes involve either bonding fibres that form a fibrous web, or filaments laid into a web of loops. Bonding can be chemical adhesion, thermally tacking the fibres and filaments together by various means, or hydroentangling them together. A growing trend is to laminate fibrous webs and filament-laid webs in order to impart special properties to the fabric. The centrifugal process offers the opportunity to engineering such fabrics incorporating many of the above-mentioned special structures. A first set of parallel bowls would provide the melt-spun filaments, including core yarns if required. These would be laid in parallel (in the machine direction or cross direction—a second set could be used to enable both directions) or as a web of loops. A final set or multiple set of bowls would then be used to produce fibres of various types if needed, i.e. including ultra-fine and nanofibres. The material may be conducting, bi- or multi-component, etc. It would be evident that separate filament and staple non-wovens can also be made.

The fibres or filaments of the invention may be manufactured using apparatus known per se, e.g. such as that described in the prior art of EP 0 469 743 which is incorporated herein by reference. However, it is an important aspect of the process of the invention that a spinning bowl is provided with one or more baffles, i.e. baffles which are coaxial with the axis of the spinning member.

Thus, apparatus comprising the aforementioned baffles is novel per se.

Therefore, according to a yet further aspect of the invention we provide a centrifugal spinning apparatus comprising an annular spinning member provided with an inlet end and an outlet end, the annular spinning member being rotatably mounted on an axis, and being provided with a coaxially mounted spinning plate, drive means for rotating the annular member and the plate, the apparatus also being provided with material feed means having an exit in the annular member adjacent the plate, the member having a plurality of spinning points formed on the external periphery of the outlet end thereof and grooves which extend across the outlet end of the spinning member from the interior surface to the external periphery thereof to direct material in liquid form to the spinning points and wherein axial directed cooling means is provided at the inlet end of the annular spinning member characterised in that, external to the outlet end of the spinning member the apparatus is provided with one or more axially extending baffles.

The centrifugal spinning process and apparatus of the invention may be applied using a variety of techniques which are illustrated by, but shall not be limited to those hereinafter described which include, for example, melt spinning, wet spinning, dry spinning, gel spinning, phase-separation spinning, reaction spinning.

Thus, according to a yet further feature of the invention we provide a process for manufacturing a fibre or filament according to claim 1 which comprises the use of a centrifugal spinning apparatus comprising an annular spinning member provided with an inlet end and an outlet end, the annular spinning member being rotatably mounted on an axis, and being provided with a coaxially mounted spinning plate, drive means for rotating the annular member and the plate, the apparatus also being provided with material feed means having an exit in the annular member adjacent the plate, the member having a plurality of spinning points formed on the external periphery of the outlet end thereof and grooves which extend across the outlet end of the spinning member from the interior surface to the external periphery thereof to direct material in liquid form to the spinning points and wherein axial directed cooling means is provided at the inlet end of the annular spinning member characterised in that, external to the outlet end of the spinning member the apparatus is provided with one or more axially extending baffles.

Conventionally the above techniques use extrusion through a spinneret to form the polymer streams. The Centrifugal Process employs centrifugal forces to form the streams.

In the process of the invention, the draw rate may vary depending upon, inter alia, the chemical nature of the polymer. However, an illustrative draw rate is from 200 to 600 m/min, e.g. 400 m/min.

The invention will now be described by way of example only and with reference to the accompanying drawings, in which

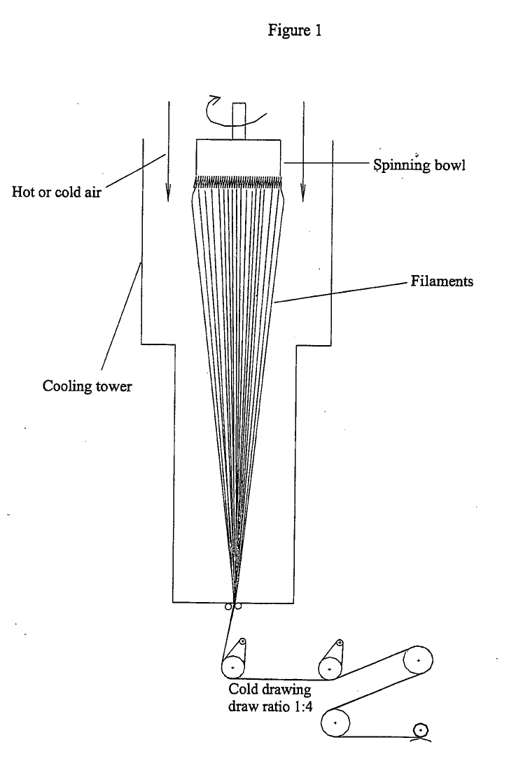

FIG. 1 is a schematic representation of the grooved melt spinning apparatus;

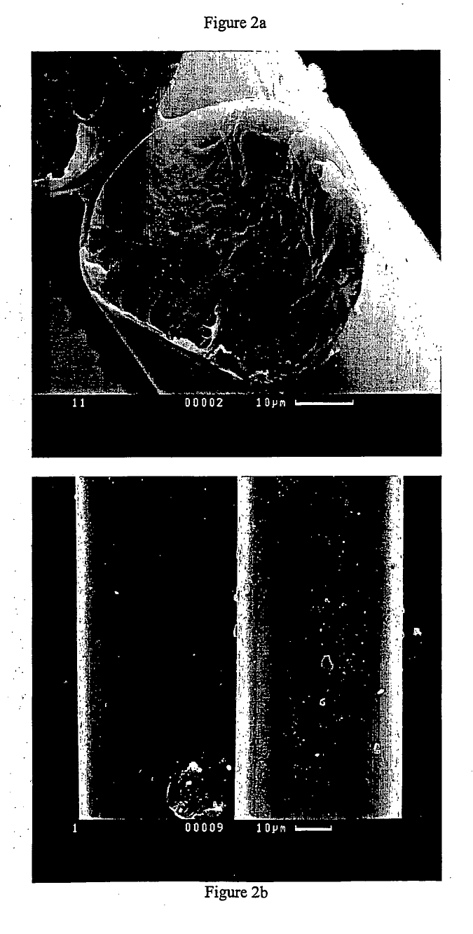

FIGS. 2 to 5 are Scanning Electron Micrographs (SEMs) of polypropylene fibres produced according to the invention, wherein

FIGS. 2a and 2b correspond to Experiment 1 and is an example of highly filaments;

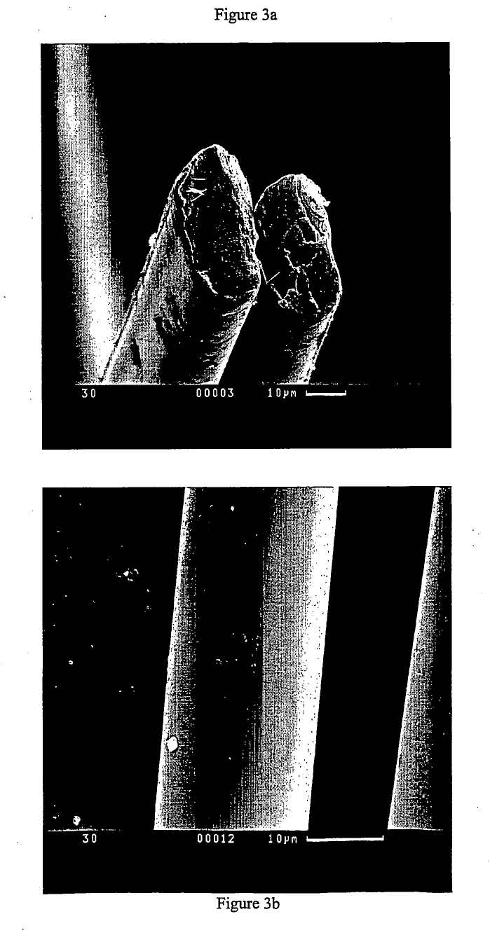

FIGS. 3a and 3b correspond to Experiment 30;

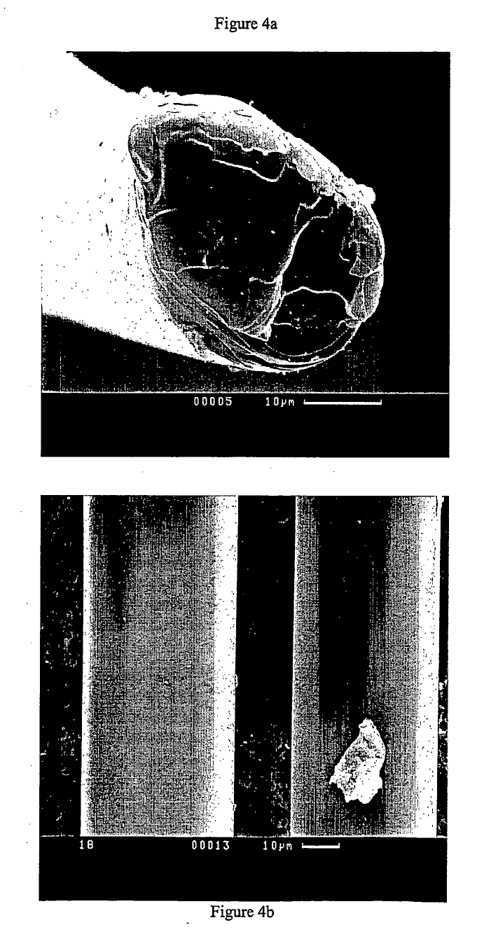

FIGS. 4a and 4b correspond to Experiment 18;

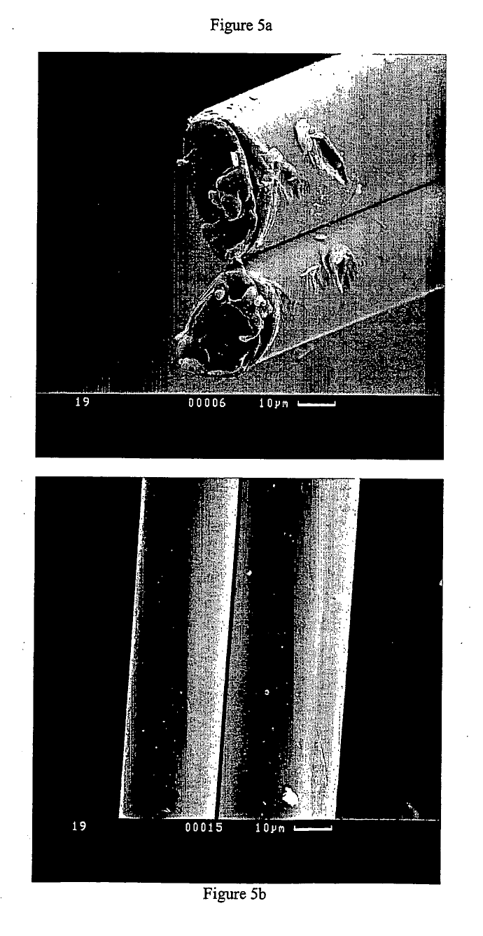

FIGS. 5a and 5b correspond to Experiment 19;

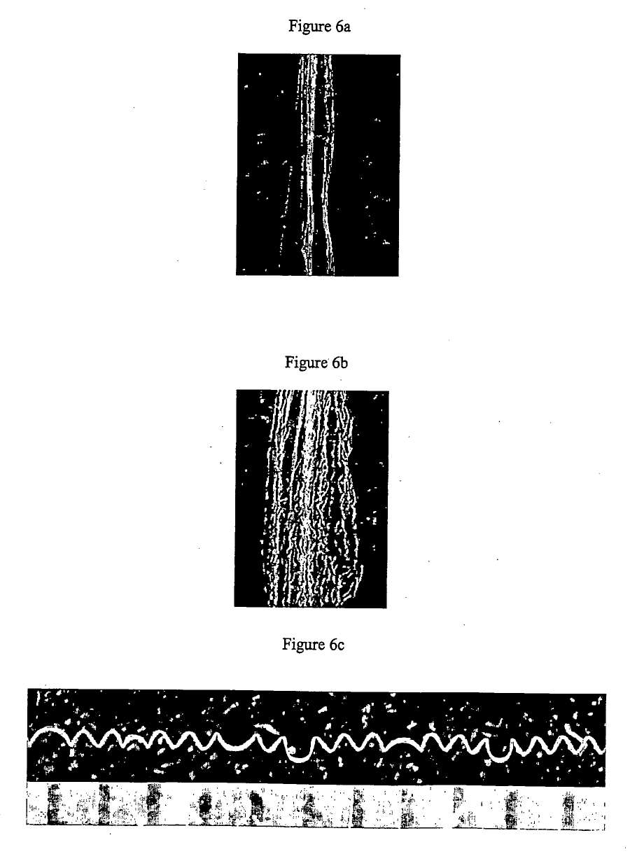

FIGS. 6a, and b are photographs of polypropylene after spinning (6a) and after drawing (6b); and

FIG. 6c is a photograph illustrating a single fibre crimp density.

### EXAMPLE 1

Fundamental Principles of Groove System

FIG. 1 illustrates the assembled components of the groove system for the melt spinning technique. The drop plate is attached to and rotates with the bowl. Resin chips are fed through a stationary tube and on hitting the drop plate are thrown onto the inner wall of the bowl. The bowl is inductively heated (heating can be achieved by other means) and therefore the resin chips melt when in contact with the bowl. The actions of centrifugal forces and gravity enable the molten polymer to flow down the inner wall of the bowl. On meeting the spinning points (serration/grooves) at the rim of the bowl the polymer is spilt into molten filament streams. These are cooled in a controlled manner by an airflow around the bowl to produce filaments or fibres.

A modification to the bowl may allow the other spinning techniques to be applied.

### EXAMPLE 2

Centrifugally Spun Polypropylene Bulked (Texturised) Filaments

Polyprene filaments were produced using the apparatus and process of the invention. The filaments were manufactured achieving the following specification:

| Production of filaments | | 400 m/min |
|---|---|---|
| Before cold drawing | | |
| Yarn diameter & tex | | 28.35 μ & 5.74 dtex |
| | | Flat (un-crimped) |
| Physical properties | Max. load at break | 7.91 gr |
| | Extension at break | 100.60 mm |
| | Tenacity | 11.71 gf/tex |
| | Tensile | 5.00 |
| After cold drawing | | |
| Yarn diameter & tex | | 14.10 μ & 1.42 dtex |
| | | Filaments crimped with |
| | | no extra process required |
| Physical properties | Max. load at break | 6.83 gr |
| | Extension at break | 8.12 mm |
| | Tenacity | 38.30 gf/tex |
| | Tensile | 0.37 |

1. A fiber or filament comprising a substantially amorphous outer surface and a more oriented core.

2. A fiber or filament according to claim 1 wherein the core comprises a series of connected elements which are substantially oriented.

3. A fiber or filament according to claim 1 wherein the core comprises a substantially oriented polymer.

4. A fiber or filament according to claim 1 wherein the core is substantially crystalline.

5. A fiber or filament according to claim 1 wherein the chemical nature of the outer surface and the core may are substantially the same chemical moiety.

6. A fiber or filament according to claim 1 wherein the chemical nature of the outer surface and the core are substantially different.

7. A fiber or filament according to claim 6 wherein the fiber or filament comprises a relatively dense core and a relatively less dense outer surface.

8. A fiber or filament according to claim 7 wherein the bicomponent system comprises a polypropylene/polyethylene composite.

9. A fiber or filament according to claim 8 wherein the bicomponent system comprises a dense polypropylene core with a less dense polyethylene outer surface.

10. A fiber or filament according to claim 1 wherein the bicomponent system comprises a dense polyethylene core with a less dense polypropylene outer surface.

11. A fiber or filament according to claim 1 wherein the amorphous outer surface comprises from 1 to 20% of the thickness of the fiber or filament.

12. A fiber or filament according to claim 1 wherein the fiber or filament has a median diameter of about 50 μm.

13. A fiber or filament according to claim 1 wherein the amorphous outer surface has a thickness of from 0.5 to 10 μm in thickness.

14. A fiber or filament according to claim 1 comprising a self bulking fiber or filament.

15. A method of bulking a fiber or filament comprises comprising a substantially amorphous outer surface and a more oriented core comprising cold drawing, stretching and releasing said fiber or filament.

16. A fiber or filament according to claim 1 wherein the fiber or filament is selected from the group consisting of thermally sensitive polymers, ultrafine/nanofibres, self-bulking filament yarns, conductive fibers and filaments, bicomponent & multi-component filaments and fibers, porous fibers and filaments, hollow fibers and filaments, ceramic precursor fibers and filaments, fiber reinforced composite precursor filaments, highly wicking filaments and non-woven fabrics.

17. A centrifugal spinning apparatus comprising an annular spinning member provided with an inlet end and an outlet end, the annular spinning member being rotatably mounted on an axis, and being provided with a coaxially mounted spinning plate, drive means for rotating the annular member and the plate, the apparatus also being provided with material feed means having an exit in the annular member adjacent the plate, the member having a plurality of spinning points formed on the external periphery of the outlet end thereof and grooves which extend across the outlet end of the spinning member from the interior surface to the external periphery thereof to direct material in liquid form to the spinning points and wherein axial directed cooling means is provided at the inlet-end of the annular spinning member characterised in that, external to the outlet end of the spinning member the apparatus is provided with one or more axially extending baffles.

18. A method for manufacturing a fiber or filament comprising a substantially amorphous outer surface and a more oriented core, wherein said method comprises the use of a centrifugal spinning apparatus comprising an annular spinning member provided with an inlet end and an outlet end, the annular spinning member being rotatably mounted on an axis, and being provided with a coaxially mounted spinning plate, drive means for rotating the annular member and the plate, the apparatus also being provided with material feed means having an exit in the annular member adjacent the plate, the member having a plurality of spinning points formed on the external periphery of the outlet end thereof and grooves which extend across the outlet end of the spinning member from the interior surface to the external periphery thereof to direct material in liquid form to the spinning points and wherein axial directed cooling means is provided at the inlet end of the annular spinning member characterised in that, external to the outlet end of the spinning member the apparatus is provided with one or more axially extending baffles.

19. The method according to claim 18 wherein the method of manufacturing a fiber or filament further comprises melt spinning, wet spinning, dry spinning, gel spinning, phase-separation spinning or reaction spinning.

20. (canceled).

21. A method for producing a continuous fiber or filament comprising a substantially amorphous outer surface and a more oriented core, wherein said method comprises:
introducing resin chips into a bowl;
heating the bowl to allow the resin chips to melt and form a molten polymer;
centrifugally spinning the bowl so the molten polymer is split into molten filament streams; and
cooling the filament streams to produce the a fiber or filament.
